(19) United States
(12) Patent Application Publication
(10) Pub. No.: US 2016/0054137 A1
(43) Pub. Date: Feb. 25, 2016

(54) NAVIGATION DEVICE WITH ENHANCED WIDGETS AND APPLICATIONS

(71) Applicant: TomTom International B.V., Amsterdam (NL)

(72) Inventors: Jonathan Wheatman, Gemert (NL); Joost Remijn, Amsterdam (NL); Sébastien Bruno Jean-François Ruffino, Croissy sur Seine (FR); Rolf Dorland, Lelystad (NL)

(21) Appl. No.: 14/463,962

(22) Filed: Aug. 20, 2014

(51) Int. Cl. G01C 21/36

(52) U.S. Cl. CPC G01C 21/36

(57) ABSTRACT

A navigation device is disclosed which has a navigation application and one or more third party application installed thereon. At least some of the third party applications are able to interact with the navigation application via an API to obtain data therefrom, and optionally provide data thereto. A home screen of the navigation device simultaneously displays a navigation widget associated with the navigation application, which displays navigation instructions provided by the navigation application to guide a user along a determined route, and at least one widget and/or shortcut associated with a third party application.

### FIELD OF THE INVENTION

This invention relates to navigation devices that include means for determining their current location, such navigation devices including portable navigation devices (so-called PNDs) and embedded vehicle systems.

### BACKGROUND TO THE INVENTION

Navigation devices, such as portable navigation devices (PNDs), that include global navigation satellite systems (GNSS), e.g. global positioning system (GPS), signal reception and processing functionality are well known, and are widely employed as in-car or other vehicle navigation systems. It will be appreciated, that navigation devices may use other means to determine their location, such as using the mobile telecommunications, surface beacons or the like.

In general terms, a modern navigation device comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the navigation device to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In a particularly preferred arrangement the output interface display may be configured as a touch sensitive display (by means of a touch sensitive overlay or otherwise) to additionally provide an input interface by means of which a user can operate the device by touch.

Devices of this type will also often include one or more physical connector interfaces by means of which power, and optionally data signals, can be transmitted to and received from the device, and optionally one or more wireless transmitters/receivers to allow communication over cellular telecommunications and other signal and data networks, for example Wi-Fi, Wi-Max GSM and the like.

Navigation devices of this type also include a GPS antenna by means of which satellite-broadcast signals, including location data, can be received and subsequently processed to determine a current location of the device.

Navigation devices may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically such features are most commonly provided in in-vehicle navigation systems, but may also be provided in PND devices if it is expedient to do so.

The utility of such navigation devices is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths or other points of interest), and favourite or recently visited destinations.

Typically, the navigation device is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account historical, existing and/or predicted traffic and road information.

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs will typically be mounted on the dashboard or windscreen of a vehicle, but navigation devices may also be formed as part of an on-board computer of the vehicle radio or indeed as part of the control system of the vehicle itself. The navigation device may thus be part of a hand-held system, such as a PDA (Portable Digital Assistant) a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, an on-line route planning and navigation facility is provided at routes.tomtom.com, which facility allows a user to enter a start point and a destination, whereupon the server to which the user's PC is connected calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a navigation device, once a route has been calculated, the user interacts with the navigation device to select the desired calculated route, optionally from a list of proposed routes. Optionally, the user may intervene in, or guide, the route selection process, for example by specifying that certain routes, roads, locations or criteria are to be avoided or are mandatory for a particular journey. The route calculation aspect of the navigation device forms one primary function, and navigation along such a route is another primary function.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above provide a reliable means for enabling users to navigate from one position to another.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of the current road and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

As mentioned above, there are a number of typical ways of providing navigation instructions to a user to allow them to follow a predetermined route; such navigation instructions commonly being referred to as turn-by-turn instructions. Most rely on displaying a representation of the world, and typically the road network, around the current position of the device and/or user, together with graphical icons indicating the current position of the device and/user and the route to be followed. The representation of the world will typically be a computer generated image from a particular point of view, and may be a two-dimensional (2D) or three-dimensional (3D) view.

While existing navigation devices have proved of great utility in providing pure navigation functionality, e.g. in determining a route and providing navigation instructions for guiding a user along the route, the Applicant has realised that there are many other (software) applications which would benefit from enhancement with navigation related features. The Applicant has realised that there remains a need for a navigation device which may integrate the provision of navigation information with other applications which would benefit from navigation enhancement.

### SUMMARY OF THE INVENTION

In accordance with a first aspect of the invention there is provided a navigation device arranged to access digital map data indicative of a navigable network, and comprising: a display device; a user input device; a location determining device arranged to determine a current position of the device; and one or more processors arranged to:

execute a navigation application operable to determine a route from an origin to a destination through the navigable network using the digital map data, and to provide navigation instructions to guide a user along a determined route;

execute at least one further application, each said further application being an application which has been obtained, on request by a user, from a remote computer and installed on the navigation device, and each said further application being capable of being uninstalled, on request by the user, from the navigation device, wherein said at least one further application is capable of interacting with the navigation application using an application programming interface (API) to at least obtain information therefrom; and

execute application launcher software, for an operating system of the navigation device, to present a home screen on the display device, said home screen including at least one of: (i) one or more selectable graphical user interface (GUI) elements, each being associated with a said further application, and which, when selected by a user using the user input device, causes the execution of the associated further application; and (ii) one or more widgets, each being associated with a said further application, and displaying information associated with the respective further application, said displayed information being updated by the respective further application,

wherein said home screen is arranged to simultaneously display a navigation widget associated with the navigation application and at least one of: a said selectable GUI element; and a said widget, said navigation widget being arranged to display navigation instructions provided by the navigation application to guide the user along a determined route.

The present invention therefore provides a navigation device which enables a navigation application to be integrated with one or more further, e.g. third party, applications, in a manner which provides those application(s) with navigation enhanced functionality. The navigation device may be a portable navigation device (PND) that is designed to be a hand-held device, or may be a device that forms part of an embedded (or integrated) vehicle system. In preferred embodiments, the navigation device may be associated with a vehicle. The navigation device is provided with a home screen which enables a user to readily exploit this functionality, through one or more shortcuts to the navigation enhanced further applications, or widgets associated therewith. The home screen displays, in at least one configuration, a navigation widget in combination with one or more shortcuts and/or widgets associated with the navigation enhanced further applications.

The present invention extends to the use of a navigation device in accordance with any of the aspects and embodiments described herein. The present invention may extend to a method of operating a navigation device in accordance with the invention in any of the aspects and embodiments described, e.g. to display the home screen on the display device. The present invention may provide a method of operating the navigation device, comprising: causing the one or more processors to execute the application launcher software so as to present the home screen on the display device, wherein the home screen simultaneously displays the navigation widget associated with the navigation application and the at least one selectable graphical user interface (GUI) element and/or widget, said navigation widget displaying navigation instructions provided by the navigation application to guide the user along a determined route. The method may comprise, where the home screen includes one or more selectable GUI, executing the associated further application in response to detecting that the GUI element has been selected by a user using the user input device.

The present invention may also extend to a method of configuring such a navigation device, and thus according to a further aspect of the invention there is provided a method of configuring a navigation device arranged to access digital map data indicative of a navigable network, and comprising: a display device; a user input device; a location determining device arranged to determine a current position of the device, the method comprising configuring the device such that one or more processors are arranged to:

execute a navigation application operable to determine a route from an origin to a destination through the navigable network using the digital map data, and to provide navigation instructions to guide a user along a determined route;

execute at least one further application, each said further application being an application which has been obtained, on request by a user, from a remote computer and installed on the navigation device, and each said further application being capable of being uninstalled, on request by the user, from the navigation device, wherein said at least one further application is capable of interacting with the navigation application using an application programming interface (API) to at least obtain information therefrom; and

execute application launcher software, for an operating system of the navigation device, to present a home screen on the display device, said home screen including at least one of: (i) one or more selectable graphical user interface (GUI) elements, each being associated with a said further application, and which, when selected by a user using the user input device, causes the execution of the associated further application; and (ii) one or more widgets, each being associated with a said further application, and displaying information associated with the respective further application, said displayed information being updated by the respective further application,

wherein said home screen is arranged to simultaneously display a navigation widget associated with the navigation application and at least one of: a said selectable GUI element; and a said widget, said navigation widget being arranged to display navigation instructions provided by the navigation application to guide the user along a determined route.

As will be appreciated by those skilled in the art, these further aspects of the present invention can and preferably do include any one or more or all of the preferred and optional features of the invention described herein in respect of any of the other aspects of the invention, as appropriate. If not explicitly stated, the device of the present invention herein may comprise means for carrying out any step described in relation to a method of the invention in any of its aspects or embodiments, and vice versa.

The navigation device is arranged to access digital map data indicative of a navigable network. The navigation device may be arranged to access the digital map data from any repository storing digital map data pertaining to the navigable network. In some embodiments the navigation device is arranged to access the digital map data from a remote repository. The device may be arranged to access the digital map data wirelessly from a repository stored by a remote server. In other embodiments the navigation device comprises the repository. The device may comprise a memory storing the repository. Of course, the digital map data might be obtained solely from a remote repository or from a repository of the device, i.e. a local repository, or from any combination thereof. The navigable network comprises a plurality of navigable segments connected by a plurality of nodes. The digital map data comprises data indicative of the plurality of navigable segments and plurality of nodes of the navigable network in a geographic region covered by the digital map.

The navigation device comprises a display device and a user input device. The user input device may comprise any number of input devices, including a keyboard device, voice input device, touch panel and/or any other known input device utilised to input information. The display device comprises a display screen, which can include any type of display screen such as a liquid crystal display (LCD), for example. In one embodiment, the input device and the display screen are integrated so as to provide an integrated input and display device, including a touchpad or touchscreen input to enable both input of information and display of information through the touch panel screen. In this respect, the device may comprise a set of one or more processors arranged to execute a graphical user interface (GUI) that operates in conjunction with the touchscreen.

The navigation device further comprises a location determining device; the navigation device is thus portable, i.e. capable of traversing the navigable network, whether embodied as a hand-held PND or mounted on or within a vehicle. The location determining device may comprise any location detection means for determining the location of the device, e.g. a global navigation satellite system (GNSS), e.g. GPS or GLONASS, receiver. As will be appreciated the device may use other means for determining its current location as desired, e.g. terrestrial beacons, the mobile telecommunications network, etc.

The navigation device may comprise a memory comprising instructions which when executed by one or more processors of the device causes the navigation device to operate in accordance with the invention in any of its aspects or embodiments. The navigation device may comprise a memory storing data associated with the navigation application and/or any one of the at least one further application.

The navigation device comprises a set of one or more processors arranged to execute a navigation application operable to determine a route from an origin to a destination through the navigable network using the digital map data, and to provide navigation instructions to guide a user along a determined route. The navigation application may be configured to provide this functionality in any suitable manner. The navigation application may comprise a routing engine arranged to determine one or more routes from an origin to a destination. The or each route may be determined according to a given cost function (e.g. fastest, most economical, shortest, etc), and optionally one or more preferences, which may be user specified, e.g. to avoid highways, take scenic routes, etc.

The navigation application comprises a guidance engine arranged to generate navigation instructions to guide a user along a determined route. As referred to herein, navigation instructions may comprise detailed turn-by-turn navigation instructions. Such instructions may be output in various manners e.g. in the form of a turn list, using spoken instructions and/or guidance icons. In some preferred embodiments the navigation instructions are provided by reference to a representation of a current position of the navigation device in the navigable network and at least a portion of the remainder of the determined route. The representation may be updated as the user traverses the route toward the destination. However, it will be appreciated that rather than providing such a map type view of the route, instead the navigation instructions may be in the form of a display of an upcoming turn or turns, i.e. a single image snap shot showing the next action to be taken to continue to follow the route, and without necessarily providing a route overview.

The navigation application preferably comprises a search engine to enable a user to query the digital map data to find a location of interest, e.g. an address or POI.

The navigation application preferably comprises a positioning and map matching engine to enable positioning information obtained from the location determining device to be used to appropriately locate the device on the navigable network. The positioning and map matching engine will attempt to match raw positioning information to be matched to a position on a navigable segment of the navigable network as represented by the digital map data; such matched positions being commonly referred to as map-matched positions.

The navigation application comprises a map rendering engine. This may be arranged to use the digital map data to provide one or both of a 2D and 3D map view. The map rendering engine may be arranged to provide 3D representations of buildings and landmarks.

In accordance with the invention the navigation device also comprises a set of one or more processors arranged to execute at least one further application. The or each at least one further application is in addition to the navigation application. The or each further application is an application that is capable of being obtained, on request by a user, from a remote computer and installed on the navigation device, and is also capable of being uninstalled, on request by a user, from the navigation device. The further application may be received wirelessly, i.e. over the air, from a remote computer, or through any appropriate communication link with a remote computer, whether wired or wireless. The at least one further application that the one or more processors of the PND are arranged to execute is therefore an application which has been obtained, on request by a user, from a remote computer and installed on the navigation device, and is also capable of being uninstalled, i.e. deleted, on request by a user, from the navigation device. The or each further application is therefore a third party application that has been selected by a user and installed on the device. The application is an application that may be freely installed or uninstalled on the PND by a user. The application is not an integral part of the device which could only be installed upon initial set up of the device, but may be installed or uninstalled at will without impacting upon the normal operation of the PND. A further application may be of any desired type, according to a user's needs and wishes. In embodiments the or each further application is not a navigation application.

In contrast to the at least one further application which may be installed or uninstalled from the PND at will by a user, the navigation application forms a permanent or integral part of the device. While it may be possible to uninstall the navigation application by resetting the device, it may not be freely uninstalled, i.e. deleted by a user, and is intended to remain installed on the device during normal operation. The navigation application will remain installed on the device while one or more of the at least one further application is installed and/or uninstalled. The navigation application is not a third party application.

The navigation application is provided with an application programming interface (API) that permits interaction between at least one further application and the navigation application. This enables the at least one further application to at least obtain information from the navigation application. Typically, therefore, the developers of the at least one further application utilise a software development kit (SDK) for the navigation application, such that the at least one further application can send information in the appropriate manner to the navigation application, and can interpret information received from the navigation application.

A further application that is capable of interacting with the navigation application via the API in this way may be referred to as a “navigation enabled” or “navigation enhanced” application. The API preferably permits two way interaction between the navigation application and the at least one further application. Preferably the API enables the at least one further application to provide data to the navigation application. For example, a further application may obtain data from the navigation application for display within the at least one further application. Such information may comprise an estimated time of arrival associated with a route being followed. Conversely a further application may provide data to the navigation application, which can be used by the navigation application as part of a routing and/or navigation operation. For example, the further application may provide any of the following to the navigation application: a destination to which it is desired to navigate, an instruction to cancel a current route, or an instruction to recalculate an existing route. In some embodiments, interaction of the at least one further application with the navigation application using the API enables the further application to perform geocoding and/or reverse geocoding. Geocoding refers to the process of determining a set of geographic coordinates (e.g. latitude, longitude) from a textual location, e.g. an address or place name (i.e. in the form of text or text string). Reverse geocoding refers to the reverse process of obtaining a textual location, e.g. an address or place name, from a set of geographic coordinates (e.g. longitude, latitude).

It will be appreciated that not every one of the further applications present on the navigation device need be navigation enabled in this manner. In some embodiments, therefore, the one or more processors of the navigation device may be arranged to execute at least one further application that is not able to interact with the navigation application (via the API). Such applications may be any, e.g. third party, applications for which navigation enhancement is not necessary or desired, e.g. a calculator application, clock application, etc. The PND may also comprise one or more further applications which are not navigation enhanced, and not of a third party type. Thus, for example, the home screen may simultaneously display a GUI element or widget associated with a navigation enhanced application, and a GUI element or widget associated with a normal, or non-navigation enhanced, application.

The navigation device comprises a set of one or more processors arranged to execute application launcher software for an operating system of the device, that when executed presents a home screen on the display device. The home screen includes one or both of: one or more selectable GUI elements; and one or more widgets. It will be appreciated that the home screen may include any combination of one or more selectable GUI elements and one or more widgets, i.e. one or more GUI elements, one or more widgets, or both one or more GUI elements and one or more widgets. It will be appreciated that either a single widget or GUI element, or a plurality thereof, may be provided either alone in combination with either a single or a plurality of the other of widgets or GUI element. To avoid confusion, a respective further application with which a GUI element is associated may be referred to as a first further application, and a respective further application with which a widget is associated may be referred to as a second further application.

Each selectable GUI element may be of any suitable form, such as an icon. Each GUI element is associated with a further application, such that, when the GUI element is selected by a user using the user input device, it causes the execution of the associated further application. The further application may be an application that is capable of interacting with the navigation application via the API. The GUI element is selectable in order to launch the associated application, e.g. to run the application full screen. In other words, each selectable GUI element provides a shortcut to the associated further application.

Each widget is associated with a further application, and displays information associated with the respective further application, the displayed information being updated by the respective further application. The further application may be an application that is capable of interacting with the navigation application via the API. The or each widget is different to the navigation widget, in that it is associated with (and displays data from) a further application which is not the navigation application. It will be appreciated that where both a widget and a GUI element are provided, they may both be associated with the same further application, although preferably the widget and GUI element are associated with different further applications.

A widget as used herein has its usual meaning in the art. The widget is a component of a graphical user interface with which the user interacts, and which displays dynamic content to the user from an associated application. The associated application will update the information displayed by the widget. The associated application will be running in the background. The dynamic content displayed by the widget to the user from the associated application will be a limited set of information selected from the associated application. The widget may be selectable by the user to bring the associated application to the foreground, e.g. to run the application full screen. This is in contrast to the selectable GUI element that may form part of the home screen, which is not running until the GUI element is selected. It will be appreciated that the above features of a widget are applicable to any widget referred to herein, regardless of the application with which it is associated, i.e. to both a widget associated with a further application or the navigation application.

The home screen, in at least one configuration, is arranged to simultaneously display a navigation widget associated with the navigation application and at least one of a selectable GUI element and a widget associated with a respective further application. Thus the home screen displays at the same time, i.e. concurrently, the navigation widget and additionally one or more selectable GUI elements and/or one or more widgets.

In a preferred embodiment, the home screen, in at least one configuration, simultaneously displays the navigation widget associated with the navigation application and a widget associated with a further application, the navigation widget being arranged to display navigation instructions provided by the navigation application to guide the user along a determined route, and said widget displaying information based on information obtained from the navigation application using the API, and relating to the determined route. The information based on information obtained from the navigation application may be obtained in any manner based on the obtained information, e.g. it may be associated with the information, or otherwise derived therefrom. The information obtained from the navigation application relating to the determined route may include one or more of: the origin and/or destination of the route; the progress along the route, e.g. an estimated time of arrival (ETA) or distance to destination remaining, etc; and the current location, which is preferably map-matched, of the device along the route. It will be appreciated that the determined route will be a current route being traversed.

It will be appreciated that the home screen may have multiple configurations. Each configuration may comprise at least one selectable GUI elements and/or at least one widget, preferably displayed simultaneously with the navigation widget. For example, the home screen may have multiple pages. It is envisaged that some pages may show only widgets and/or GUI elements, and not the navigation widget. Preferably the home screen has multiple configurations, each comprising multiple ones of the selectable GUI elements and/or widgets associated with respective further applications.

The home screen may be configurable by a user to display a desired combination of selectable GUI elements associated with further applications installed on the device and/or widgets associated with such applications. In embodiments the home screen may be populated with the one or more selectable GUI elements and/or widgets associated with further applications installed on the device by a user.

The navigation widget is arranged to display navigation instructions provided by the navigation application to guide the user along a determined route. As discussed above, the navigation instructions may be of any form, and may be provided by reference to a representation of a current position of the PND in the navigable network, and at least a portion of a remainder of the determined route. However, in other arrangements, the navigation instructions may comprise displaying a single upcoming turn in the manner of a navigation instruction “card”. In preferred embodiments the navigation widget is arranged to display a representation of a current position of the navigation device in the navigable network and a representation of at least a portion of the remainder of the determined route, the representation being updated as the user traverses the route toward the destination. The route may be a route between any origin and destination provided to the navigation application. The origin and/or destination may be input by a user. Alternatively one or both of the origin and destination may be obtained from a further application of the device. It will be appreciated that the API will permit the navigation application to obtain data from the at least one further application, which may include origin or destination data. In other possibilities, one or both of the origin and destination may be inferred by the navigation application, e.g. based on the current position, previously travelled routes, etc.

While certain features of the navigation device have been described in more detail above, the navigation device may include any desired additional features, such as at least one image capture device, e.g. camera, and/or a near field communication (NFC) device.

It is considered that the display, on the device home screen, of at least one selectable GUI element and/or at least one widget simultaneously with a navigation widget providing navigation instructions in the form of a representation of the world, and typically the road network, around the current position of the device, together with graphical icons indicating the current position of the device and the route to be followed is new and inventive in its own right.

Thus, according to another aspect of the invention there is provided a navigation device arranged to access digital map data indicative of a navigable network, and comprising: a display device; a user input device; a location determining device arranged to determine a current position of the device; and one or more processors arranged to:

execute a navigation application operable to determine a route from an origin to a destination through the navigable network using the digital map data, and to provide navigation instructions to guide a user along a determined route;

execute at least one further application, each said further application being an application which has been obtained, on request by a user, from a remote computer and installed on the navigation device, and each said further application being capable of being uninstalled, on request by the user, from the navigation device; and

execute application launcher software, for an operating system of the navigation device, to present a home screen on the display device, said home screen including at least one of: (i) one or more selectable graphical user interface (GUI) elements, each being associated with a said further application, and which, when selected by a user using the user input device, causes the execution of the associated further application; and (ii) one or more widgets, each being associated with a said further application, and displaying information associated with the respective further application, said displayed information being updated by the respective further application,

wherein said home screen is arranged to simultaneously display a navigation widget associated with the navigation application and at least one of: a said selectable GUI element; and a said widget, said navigation widget being arranged to display navigation instructions provided by the navigation application to guide the user along a determined route, wherein said navigation instructions comprise a graphical representation of a current position of the navigation device in the navigable network and at least a portion of the remainder of the determined route, the graphical representation being updated as the user traverses the route toward the destination.

The present invention may also extend to a method of configuring such a navigation device, and thus according to a further aspect of the invention there is provided a method of configuring a navigation device arranged to access digital map data indicative of a navigable network, and comprising: a display device; a user input device; a location determining device arranged to determine a current position of the device, the method comprising configuring the device such that one or more processors are arranged to:

execute a navigation application operable to determine a route from an origin to a destination through the navigable network using the digital map data, and to provide navigation instructions to guide a user along a determined route;

execute at least one further application, each said further application being an application which has been obtained, on request by a user, from a remote computer and installed on the navigation device, and each said further application being capable of being uninstalled, on request by the user, from the navigation device; and

execute application launcher software, for an operating system of the navigation device, to present a home screen on the display device, said home screen including at least one of: (i) one or more selectable graphical user interface (GUI) elements, each being associated with a said further application, and which, when selected by a user using the user input device, causes the execution of the associated further application; and (ii) one or more widgets, each being associated with a said further application, and displaying information associated with the respective further application, said displayed information being updated by the respective further application,

wherein said home screen is arranged to simultaneously display a navigation widget associated with the navigation application and at least one of: a said selectable GUI element; and a said widget, said navigation widget being arranged to display navigation instructions provided by the navigation application to guide the user along a determined route, wherein said navigation instructions comprise a graphical representation of a current position of the navigation device in the navigable network and at least a portion of the remainder of the determined route, the graphical representation being updated as the user traverses the route toward the destination.

As will be appreciated by those skilled in the art, these further aspects of the present invention can and preferably do include any one or more or all of the preferred and optional features of the invention described herein in respect of any of the other aspects of the invention, as appropriate. If not explicitly stated, the device of the present invention herein may comprise means for carrying out any step described in relation to a method of the invention in any of its aspects or embodiments, and vice versa.

The present invention is a computer implemented invention, and any of the steps described in relation to any of the aspects or embodiments of the invention may be carried out under the control of a set of one or more processors. The means for carrying out any of the steps described in relation to the system may be a set of one or more processors.

Any of the systems or methods in accordance with the present invention may be implemented at least partially using software, e.g. computer programs. The present invention thus also extends to a computer program comprising computer readable instructions that when executed by a set of one or more processors of a portable navigation device provide a device according to any of the aspects or embodiments of the invention. The computer readable instructions cause the device to operate or be configured in accordance with the present invention in any of its aspects or embodiments. The invention correspondingly extends to such a computer program installed on a non-transitory computer readable medium. Such a non-transitory computer readable medium could be a non-transitory physical storage medium such as a ROM chip, CD ROM or disk, or could be a signal such as an electronic signal over wires, an optical signal or a radio signal such as to a satellite or the like.

As will be appreciated by those skilled in the art, these further aspects of the present invention can and preferably does include any one or more or all of the preferred and optional features of the invention described herein in respect of any of the other aspects of the invention, as appropriate. If not explicitly stated, the device of the present invention herein may comprise means for carrying out any step described in relation to the method of the invention in any of its aspects or embodiments, and vice versa.

In accordance with the invention in any of its aspects or embodiments, the navigable segments are navigable segments of a navigable network in a geographic area. The geographic area is covered by a digital map. While, embodiments of the present invention are described with reference to road segments, it should be realised that the invention may also be applicable to other navigable segments, such as segments of a path, river, canal, cycle path, tow path, railway line, or the like. For ease of reference these are commonly referred to as a road segment.

Where not explicitly stated, it will be appreciated that the invention in any of its aspects may include any or all of the features described in respect of other aspects or embodiments of the invention to the extent they are not mutually exclusive. In particular, while various embodiments of operations have been described which may be performed in the method and by the apparatus, it will be appreciated that any one or more or all of these operations may be performed in the method and by the apparatus, in any combination, as desired, and as appropriate.

Advantages of these embodiments are set out hereafter, and further details and features of each of these embodiments are defined in the accompanying dependent claims and elsewhere in the following detailed description.

### BRIEF DESCRIPTION OF THE FIGURES

Embodiments of the invention will now be described, by way of example only, with reference to the accompanying Figures, in which:

FIG. 1 is a schematic illustration of an exemplary part of a Global Positioning System (GPS) usable by a navigation device;

FIG. 2 is a schematic illustration of electronic components of an exemplary navigation device;

FIG. 3 is a schematic diagram of an arrangement of mounting and/or docking an exemplary navigation device;

FIG. 4 illustrates an exemplary software stack for a navigation device in accordance with the invention;

FIGS. 5A and 5B illustrate a tile based construction for the home screen which may be used in certain embodiments; FIG. 5A depicts a single page configuration, while FIG. 5B depicts a multiple page configuration;

FIG. 6 illustrates an exemplary layout for the home screen;

FIG. 7 illustrates a home screen suitable for a device provided by a vehicle hire company to a driver of a hire vehicle;

FIG. 8 illustrates a home screen suitable for a device provided by a taxi company to a driver of a taxi;

FIG. 9 illustrates a home screen suitable for a device provided by a trucking company to a driver of a truck; and

FIG. 10 illustrates a home screen suitable for a device provided by a delivery company to a driver of a delivery vehicle.

### DETAILED DESCRIPTION OF THE FIGURES

It has been recognised that it would be desirable to provide a navigation device which combines the functionality of a navigation application with one or more further, e.g. third party, applications in a manner which permits data to be exchanged between the navigation and further applications so as to provide the further applications with navigation enhancement, and which device provides a user with an intuitive home page interface to provide access to the functionality of the navigation and further application(s).

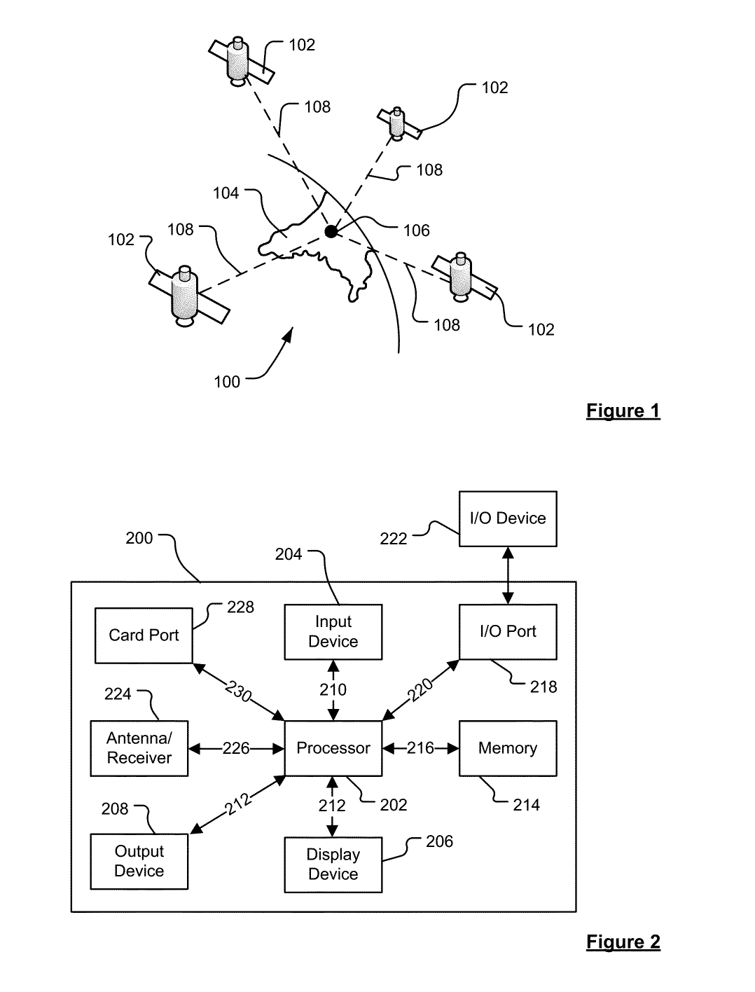

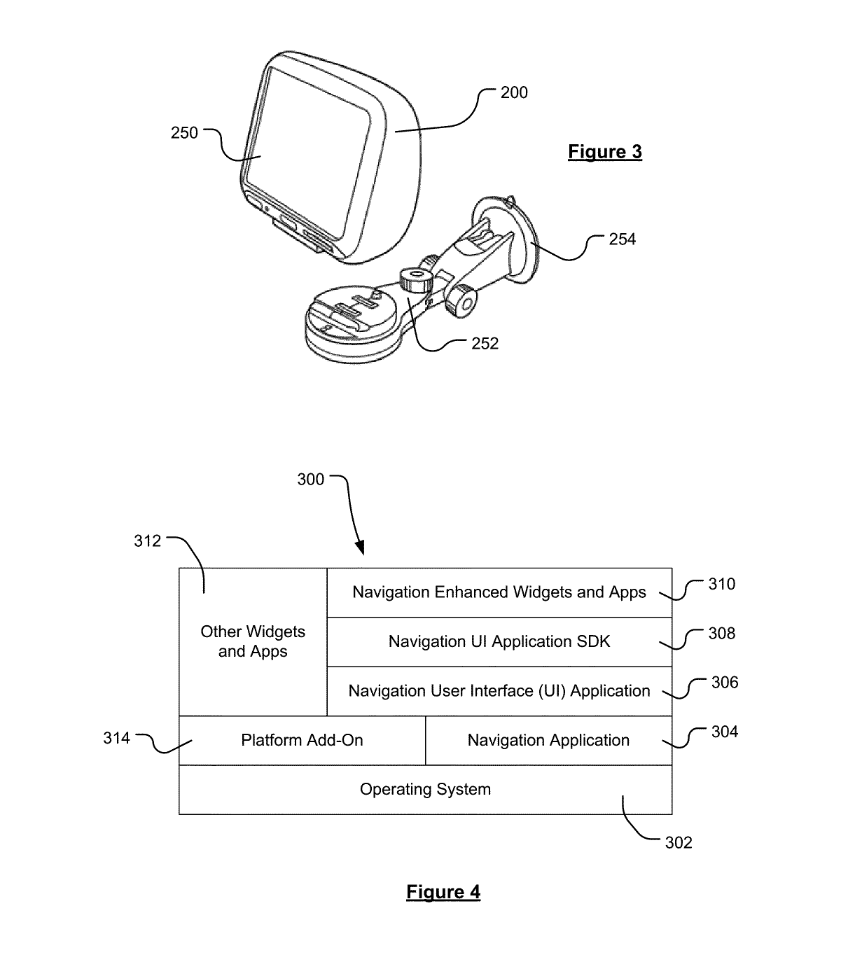

By way of background, certain features of a portable navigation device (PND) which may be used in accordance with the present invention will now be described, together with some features of its operation. The features described by reference to FIGS. 1 to 3 correspond to features of a conventional PND. The way in which the PND is modified in accordance with the invention will be described below by reference to FIG. 4 onward.

With the above provisos in mind, the Global Positioning System (GPS) of FIG. 1 and the like are used for a variety of purposes. In general, the GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location, as GPS data, to any number of receiving units. However, it will be understood that Global Positioning systems could be used, such as GLOSNASS, the European Galileo positioning system, COMPASS positioning system or IRNSS (Indian Regional Navigational Satellite System).

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal allows the receiving device to calculate its three dimensional position by the same geometrical calculation in a known manner. The position and velocity data can be updated in real time on a continuous basis by an unlimited number of users.

As shown in FIG. 1, the GPS system 100 comprises a plurality of satellites 102 orbiting about the earth 104. A GPS receiver 106 receives GPS data as spread spectrum GPS satellite data signals 108 from a number of the plurality of satellites 102. The spread spectrum data signals 108 are continuously transmitted from each satellite 102, the spread spectrum data signals 108 transmitted each comprise a data stream including information identifying a particular satellite 102 from which the data stream originates. The GPS receiver 106 generally requires spread spectrum data signals 108 from at least three satellites 102 in order to be able to calculate a two-dimensional position. Receipt of a fourth spread spectrum data signal enables the GPS receiver 106 to calculate, using a known technique, a three-dimensional position.

An exemplary navigation device 200, e.g. PND, is shown in FIG. 2; it should be noted that the block diagram of the navigation device 200 is not inclusive of all components of the navigation device, but is only representative of many example components. The navigation device 200 is located within a housing (not shown). The navigation device 200 includes processing circuitry comprising, for example, the processor 202 mentioned above, the processor 202 being coupled to an input device 204 and a display device, for example a display screen 206. Although reference is made here to the input device 204 in the singular, the skilled person should appreciate that the input device 204 represents any number of input devices, including a keyboard device, voice input device, touch panel and/or any other known input device utilised to input information. Likewise, the display screen 206 can include any type of display screen such as a Liquid Crystal Display (LCD), for example.

In one arrangement, the input device 204 and the display screen 206 are integrated so as to provide an integrated input and display device, including a touchpad or touchscreen input 250 (FIG. 3) to enable both input of information (via direct input, menu selection, etc.) and display of information through the touch panel screen so that a user need only touch a portion of the display screen 206 to select one of a plurality of display choices or to activate one of a plurality of virtual or “soft” buttons. In this respect, the processor 202 supports a Graphical User Interface (GUI) that operates in conjunction with the touchscreen.

In the navigation device 200, the processor 202 is operatively connected to and capable of receiving input information from input device 204 via a connection 210, and operatively connected to at least one of the display screen 206 and the output device 208, via respective output connections 212, to output information thereto. The navigation device 200 may include an output device 208, for example an audible output device (e.g. a loudspeaker). As the output device 208 can produce audible information for a user of the navigation device 200, it should equally be understood that input device 204 can include a microphone and software for receiving input voice commands as well. Further, the navigation device 200 can also include any additional input device 204 and/or any additional output device, such as audio input/output devices for example.

The processor 202 is operatively connected to memory 214 via connection 216 and is further adapted to receive/send information from/to input/output (I/O) ports 218 via connection 220, wherein the I/O port 218 is connectible to an I/O device 222 external to the navigation device 200. The external I/O device 222 may include, but is not limited to an external listening device, such as an earpiece for example. The connection to I/O device 222 can further be a wired or wireless connection to any other external device such as a car stereo unit for hands-free operation and/or for voice activated operation for example, for connection to an earpiece or headphones, and/or for connection to a mobile telephone for example, wherein the mobile telephone connection can be used to establish a data connection between the navigation device 200 and the Internet or any other network for example, and/or to establish a connection to a server via the Internet or some other network for example.

The memory 214 of the navigation device 200 comprises a portion of non-volatile memory (for example to store program code) and a portion of volatile memory (for example to store data as the program code is executed). The navigation device also comprises a port 228, which communicates with the processor 202 via connection 230, to allow a removable memory card (commonly referred to as a card) to be added to the device 200.

FIG. 2 further illustrates an operative connection between the processor 202 and an antenna/receiver 224 via connection 226, wherein the antenna/receiver 224 can be a GPS antenna/receiver for example and as such would function as the GPS receiver 106 of FIG. 1. It should be understood that the antenna and receiver designated by reference numeral 224 are combined schematically for illustration, but that the antenna and receiver may be separately located components, and that the antenna may be a GPS patch antenna or helical antenna for example.

It will, of course, be understood by one of ordinary skill in the art that the electronic components shown in FIG. 2 are powered by one or more power sources (not shown) in a conventional manner. Such power sources may include an internal battery and/or a input for a low voltage DC supply or any other suitable arrangement. As will be understood by one of ordinary skill in the art, different configurations of the components shown in FIG. 2 are contemplated. For example, the components shown in FIG. 2 may be in communication with one another via wired and/or wireless connections and the like. The navigation device 200 described herein is a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use. Indeed, in other embodiments, the device 200 may be arranged to be handheld to allow for navigation of a user.

Referring to FIG. 3, the navigation device 200 may be a unit that includes the integrated input and display device 206 and the other components of FIG. 2 (including, but not limited to, the internal GPS receiver 224, the processor 202, a power supply (not shown), memory systems 214, etc.). The navigation device 200 may sit on an arm 252, which itself may be secured to a vehicle dashboard/window/etc. using a suction cup 254. This arm 252 is one example of a docking station to which the navigation device 200 can be docked. The navigation device 200 can be docked or otherwise connected to the arm 252 of the docking station by snap connecting the navigation device 200 to the arm 252 for example. The navigation device 200 may then be rotatable on the arm 252. To release the connection between the navigation device 200 and the docking station, a button (not shown) on the navigation device 200 may be pressed, for example. Other equally suitable arrangements for coupling and decoupling the navigation device 200 to a docking station are well known to persons of ordinary skill in the art.

A PND in accordance with some exemplary embodiments of the invention will now be described. The PND is arranged to access digital map data indicative of a navigable network. The digital map data is preferably stored on the PND, e.g. on a memory thereof, although could be accessed wirelessly from a remote server (or indeed some combination of these possibilities).

The PND may include any or all of the features described in relation to FIGS. 1 to 3. In particular, the PND includes one or more processors, a display device, a user input device and a location determining device arranged to determine a current position of the device. The location determining device may use a global navigation satellite system (GNSS) receiver, such as a GPS, GLONASS, etc receiver, or any receiver capable of receiving wireless signals that can be used to determine a current position of the device. The PND additionally includes one or more processors arranged to execute a navigation application. These components of the PND may be in accordance with any of the exemplary arrangements described by reference to the navigation device of FIGS. 1 to 3.

The PND is, in certain exemplary arrangements, associated with a vehicle. It is envisaged that a PND in accordance with the invention may be provided by an owner to an end user. Various use scenarios will be discussed below, but in an exemplary arrangement, the owner might be a manager of a fleet of vehicles, with the end users being drivers of the vehicles. The owner may then provide each driver with a PND to be associated with their vehicle. Thus the PND may be one of a set of a plurality of similar PNDs associated with vehicles of a fleet of vehicles.

An exemplary software stack 300 for a PND in accordance with the invention will now be described by reference to FIG. 4. The software stack includes an operating system 302, a navigation application 304, a navigation user interface (UI) application 306, a navigation UI application software development kit (SDK) 308, navigation enhanced widgets and applications 310, other widgets and applications 312 and a platform add-on 314. The navigation UI application SDK 308 provides the libraries needed to allow the navigation enhanced widgets and applications 310 to interact with the navigation UI application 306, and in turn the navigation application 304. The platform add-on 314 may enable a user to customise the basic operating system, e.g. to result in certain features only being available to certain applications.

The software stack includes a navigation application 304, navigation enhanced widgets and applications 310 and other widgets and applications 312. The navigation application 304 and navigation enhanced widgets and applications 310 are the focus of the present invention, and will be described in more detail below.

The main components of the navigation application 304 will now be discussed. The navigation application is an integral part of the PND which is intended to be retained permanently, and cannot readily be installed or uninstalled by a user.

The navigation application includes a routing engine arranged to compute one or more routes to a destination according to a desired cost function. This may enable a least cost route to be obtained. Depending upon the factors included in the cost function, this may provide a fastest route, e.g. where cost is based on a traversal time for navigable segments. Alternatively a shortest or most economical route may, for example, be obtained. The routing engine may also take into account any other desired options (e.g. to avoid highways, unpaved roads, HOV lanes, ferries and toll roads). Such options may be user specified.

The navigation application also includes a guidance engine arranged to generate detailed navigation guidance instructions for a computed route. These may be used, for example, to show turn lists, to show guidance icons, and to provide spoken instructions using recorded voices and Text-To-Speech (TTS).

The navigation application includes a search engine which allows a user to query the digital map data, e.g. to find addresses and POIs.

The navigation application includes a positioning and map matching engine arranged to use raw positioning information obtained from the location determining means, e.g. GNSS (such as GPS, GLONASS, etc), to appropriately locate the device on the navigable network as represented by the digital map data (this location being the “map matched” location). The map matching engine may additionally use information obtained over WiFi or cellular networks, optionally in combination with dead reckoning and 3D positioning, in locating the device on the navigable network based on the raw positioning information.

The navigation device further comprises a map rendering engine arranged to visualize the digital map in 2D and/or 3D, optionally with 3D buildings and landmarks.

The PND includes one or more further applications, i.e. in addition to the navigation application 304. These further applications include the navigation enhanced widgets and applications (or ‘apps’) 310 and the other widgets and applications (or ‘apps’) 312. Each further application is an application that has been obtained on request by a user from a remote computer and installed on the PND. In other words, each further application is a third party application. Each further application is an application which may be freely installed or uninstalled by the user.

The PND includes an API which enables at least some of the further applications to interact with the navigation application; such further applications being navigation enhanced applications 310. This enables the further application to obtain information from the navigation application and vice versa. Thus, the interaction is a two-way interaction. Some of the navigation enhanced applications can have associated widgets that display navigation enhanced information based on information obtained from the further application. The information displayed will be updated by the respective further application.

The API permits two way interaction between the navigation application and each further application. Thus, each further application is also arranged to be able to send information to the navigation application using the API, e.g. to request a route to be planned to a destination, to cancel a current route, to recalculate an existing route. A further application may also use the API and navigation application to perform geocoding (finding a set of geographic coordinates (latitude/longitude) from a textual (or text based) location) and reverse geocoding (finding a textual (or text based) location from a set of geographic coordinates (latitude/longitude)). A textual location may be a place name or address, or other textual description of a location that may readily be understood by a human. In other arrangements the further application may simply to obtain the geographic coordinates (latitude/longitude) and/or textual location, e.g. address of a location of interest, e.g. to which a route has been determined or could be determined. It is envisaged that a further application may be able to use batch geocoding and reverse geocoding functionalities of the navigation application where provided, i.e. the simultaneous geocoding or reverse geocoding of multiple locations with one call to the navigation application.

The other widgets and applications 312 are widgets and applications which are not navigation enhanced, i.e. they are not a navigation application, or arranged to be in communication with the navigation application (e.g. via the API) in contrast to the navigation enhanced widgets and applications 310. The other widgets and applications may be any standard widgets and applications which do not require navigation enhancement, such as clock or calculator applications or widgets. These applications or widgets may or may not be third party applications and widgets.

The PND may be set up so as to enable the further, e.g. third party, applications to use a TTS engine associated with the navigation application, or the TTS engine may form part of the operating system of the navigation device.

In accordance with the invention, the PND comprises application launcher software for the operating system that, when executed, presents a particular home screen on the display device. The main features of the home screen will now be described.

The home screen includes one or more selectable icons that may each be selected by the user using the user input device to cause one of the navigation enhanced further applications to be executed. Thus, the home screen includes one or more shortcuts to respective ones of the navigation enhanced further applications. Alternatively or additionally, the home screen includes one or more navigation enhanced widgets. Each widget is arranged to display information associated with a respective one of the navigation enhanced further applications. The information displayed by the widget is updated by the respective application.

The home screen is able to simultaneously display both a navigation widget associated with the navigation application and at least one of either or both of the selectable icons and navigation enhanced widgets. The navigation widget is arranged to display navigation instructions obtained from the navigation application for guiding the user along a determined route. In preferred arrangements the navigation widget displays a representation of the current position of the navigation device on the navigable network and at least a portion of a remainder of the determined route, the representation being updated as the user traverses the route toward the destination.

It has been found to be particularly advantageous for the home screen to simultaneously display the navigation widget and at least one of the navigation enhanced widgets, associated with a respective further application. The navigation widget may then display navigation instructions provided by the navigation application to guide the user along the determined route, while the or each widget may display information based on (e.g. associated with, or derived from) information obtained from the navigation application relating to the determined route. The information from the navigation application is obtained by the further application associated with the widget from the navigation application using the API. By way of example, the information obtained from the navigation application may include one or more of; the origin and destination of the route, the progress along a current route being traversed, e.g. ETA, distance remaining etc., and the current (map-matched) position of the device on a current route.

The home page may also include one or more of the other, i.e. non-navigation enhanced, widgets, and/or one or more icons enabling one of the other (non-navigation enhanced) applications to be launched, i.e. shortcuts thereto.

In one exemplary arrangement, the navigation widget may be selected by a user to launch a full screen version of the navigation application. It is envisaged that in the full screen navigation mode, no other widgets or icons associated with other applications will be shown. The user will have to exit the full screen view and return to the home page to access such other widgets or applications. Similarly selection of one of the navigation enhanced widgets or other widgets may result in a full screen version of the associated application being launched. In some exemplary arrangements the user is not able to interact with the navigation widget, other than to cause the navigation application to go into full screen mode, e.g. by selecting or touching the navigation widget. Once full screen mode has been enabled, the user can interact with the navigation application as desired, e.g. modify routes, calculate a new route, etc.

The PND is intended to be configurable, to enable a user to install desired third party applications to be navigation enabled via the API (or otherwise), and to select widgets and icons associated with these third party applications for inclusion on the home page. The user here refers to a user that has configuration rights, who may be an owner of the PND, e.g. an owner of a fleet of vehicles with which PNDs are to be associated, rather than the end user, such as a driver.

The home page may include multiple pages. A first page might, for example, include the navigation widget (associated with the navigation application) and the one or more icons and/or widgets associated with navigation enabled applications described above, with additional pages including shortcuts to further applications, whether navigation enabled or not, and the option to browse all applications. The user may navigate between the pages in any suitable manner, e.g. using a swiping gesture.

In one exemplary arrangement, the home screen is made up of a plurality of user-definable tiles. For example, there may be 8 such tiles, laid out in two rows by four columns (although of course any number of such tiles may be provided per page). There may be any number of such pages, e.g. up to 32, but usually 2 to 3 will suffice. A user may then populate the tiles with either shortcuts to navigation enhanced applications, or indeed any other applications, and/or interactive widgets (whether navigation enhanced or not). A shortcut may be provided in the form of a button with an icon and title text, which may be selected by a user to launch a full screen version of the given application associated with the shortcut. A widget will be an interactive view that may span multiple tiles, and which may display dynamically updated or animated information. A user may be able to interact with the widget or launch a full screen version of the associated application by selecting the widget. A tile may be configured such that when selected, a tile for each application currently installed on the PND will be displayed.

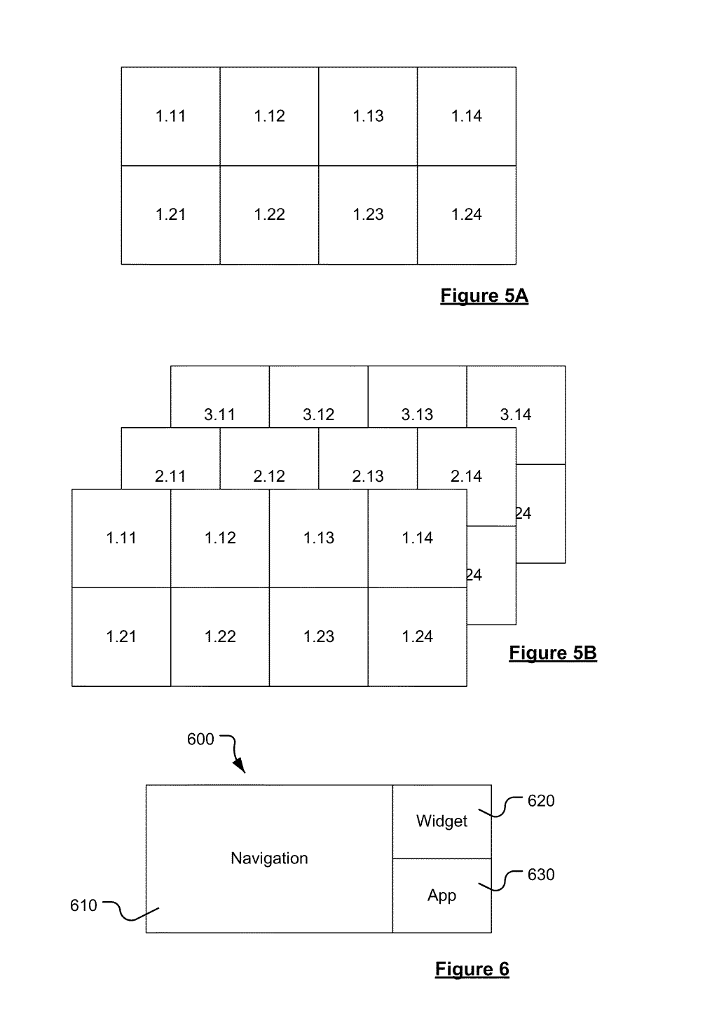

On such tile based arrangement of a home page including a single page of 8 tiles arranged in columns and rows is shown in FIG. 5A. The navigation widget may be configured to span tiles 1.11, 1.12, 1.21 and 1.22; with shortcuts provided on each of tiles 1.13, 1.14, 1.23 and 1.24, or alternatively a navigation enabled widget may be located in the position of one of these tiles in place of a shortcut. FIG. 5B shows a further tile based arrangement including three pages of 8 tiles. As will be appreciated, the user can choose to vary or adjust the number of tiles a widget spans as desired.

Another exemplary layout which may be obtained using a tile based system is shown in FIG. 6. Here the home screen 600 includes a navigation widget 610, a navigation enabled third party widget 620 and a shortcut to a, possibly navigation enabled, third party application 630. It will be appreciated that the home screen may include the navigation widget and any combination of navigation enabled shortcuts and widgets. One or a plurality of shortcuts to navigation enabled applications may be provided alone, or in combination with one or more navigation enabled widgets. Similarly one or more shortcuts to non-navigation enabled applications, or non-navigation enabled widgets may additionally, (though optionally), be provided.

It is envisaged that the PND may comprise functionality to enable or disable application shortcuts from the home page dynamically. For example, the speed of a vehicle with which the PND is associated may be monitored via a navigation enabled application running in the background. Shortcut icons on the home screen may then be enabled or disabled when certain threshold speeds are reached, e.g. icons may be disabled when the speed exceeds a given threshold, and enabled when the speed falls below the threshold.

As mentioned above, the PND may be configured by a user who is an owner of the device, and differs from an end user. The PND may be arranged to have two (or more) user access profiles. These may be in respect of an owner and end user, allowing the owner to restrict the user's access to certain settings, applications. The owner may be provided with full rights to configure the device, e.g. to set up the icons and/or widgets displayed on the home screen, while the end user may be provided with more limited rights to customise the device. For example, the owner may be able to delete applications, and fix bugs, while the end user may be limited to only being able to run applications, install and uninstall third party applications, and change certain settings. A user may be permitted to use only certain applications.

The PND may be arranged to be able to receive updates over the air, e.g. using Wi-Fi. This will enable updates to be sent out to multiple PNDs simultaneously. For example, an owner may send out updates to a set of PNDs associated with fleet vehicles. This might be achieved by sending out the updates over a Wi-Fi network associated with a garage where the devices are kept overnight, to allow all devices to be updated at once. In other embodiments, PNDs can, additionally or alternatively, be updated using files on a SD-card.

In some arrangements it is possible to clone a device by having a device transmit data indicative of its configuration over the air to a remote device, or to a memory, e.g. SD card, which may then be used to copy the data to another device. Thus, once a PND has been configured as desired, other PNDs may then easily be set up in the same manner. An option may be provided which may be selected by a user to cause the device to export its settings either over the air or to a memory, e.g. SD card, associated with the device. A similar option may be provided to allow settings to be exported to a back-up file.

The PND may also be arranged to display a navigation bar providing quick launch icons for applications. This may make switching between (or launching of) applications easier. For example the navigation bar may include icons which provide shortcuts to a limited number of applications e.g. 1 or 2, to enable a quick launch for those applications. The device may be configured to permit applications to be removed from the navigation bar e.g. by pressing and holding the relevant icon.

The PND may include one or more camera. The PND may be provided with short range and longer range communication capability, e.g. Bluetooth, WiFi, Near Field Communication (NFC), etc.

The PND may be of any suitable size. However, it has been found that at least in the context of use with one of a fleet of vehicles, it is advantageous for the PND to be relatively rugged and with a relatively large screen, e.g. a 7 inch display, to facilitate use.

The PND may permit screenshots to be taken, e.g. by selecting an icon.

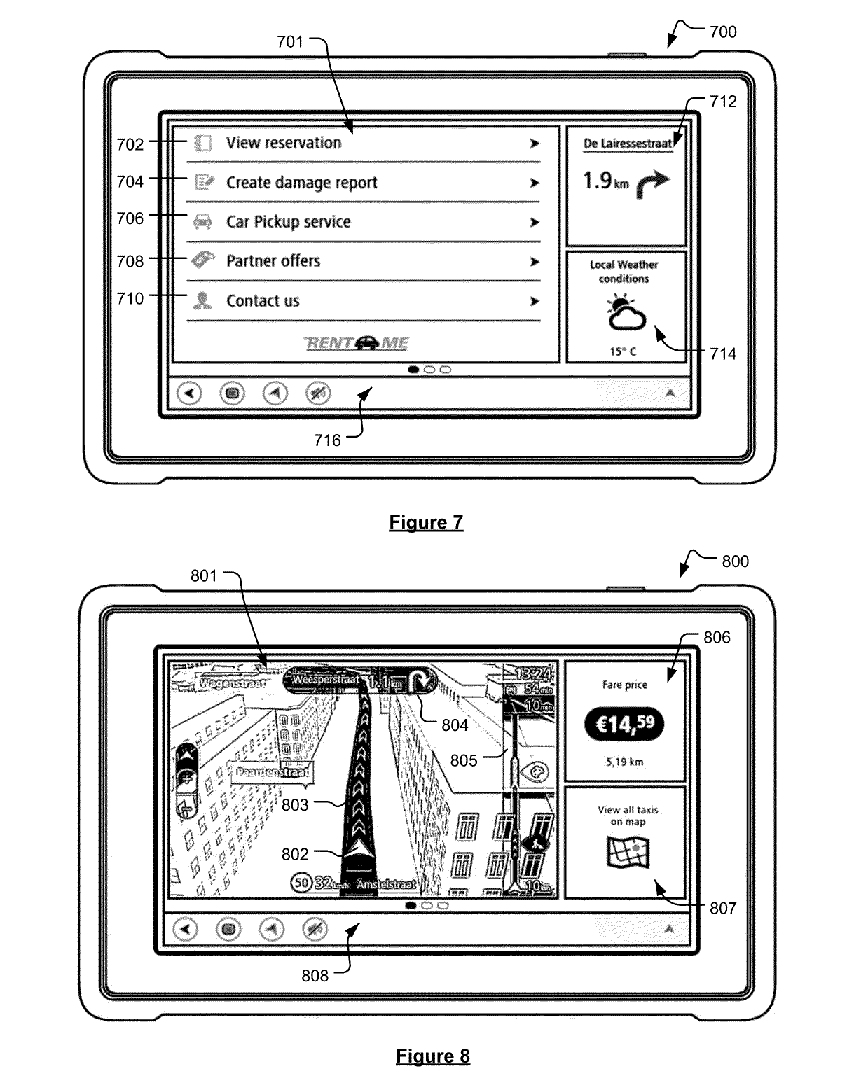

Some exemplary arrangements for the home screen will now be described by reference to various possible use scenarios in FIGS. 7 to 10.

FIG. 7 illustrates a home screen 700 which is used for a PND provided with one of a fleet of hire vehicles. The PND is owned by the hire company, and is intended to be used by someone driving the hire vehicle. The hire company has installed an application relating to their vehicle hire service.

The home screen includes, on the left, a widget 701 providing shortcuts 702, 704, 706, 708 and 710 respectively to different functions of the application for viewing a reservation, creating a damage report, performing functions relating to a car pick up service, partner offers, and to enable the user to contact the company. Each of these shortcuts may be selected by a driver to launch a full screen version of the application, e.g. on a page or screen associated with the appropriate function. Other examples of applications (or functions within the main application) that the service provider might install would include providing step-by-step guidance as to how to fix a puncture. The damage report functionality may enable a user to take a photo of the damage and send it to the rental company, avoiding the need to return there in person. The application installed by the vehicle hire service provider is navigation enabled, and thus able to interact with the navigation application via the API. For example, the application when performing the create damage report function 704 may obtain information about a current position of the vehicle from the navigation application, for transmission as part of a damage report. Similarly, the application when performing the car pickup service function 706 may obtain the current location of the vehicle from the navigation application for transmission to the vehicle rental company.

On the right, the home screen includes a navigation widget 712 associated with a navigation application installed on the device (which is provided by the navigation application provider, rather than the vehicle hire company). The navigation widget is displaying navigation instructions for guiding the user along a calculated route. In this example the navigation instructions are in the form of an instruction “card”, showing the next manoeuvre to be performed, rather than indicating progress of the vehicle with respect to a representation of the route. The navigation application may be selected by a user to launch a full screen version of the application. This may, for example, show a representation of the route being followed.

Below the navigation widget 712 there is a weather widget 714, showing local conditions. The weather widget 714 is associated with a weather application installed on the device. The weather widget 714 is a navigation enhanced widget, being associated with a weather application that is able to interact with the navigation application via an API of the PND. This enables the weather widget to obtain details of a current position from the navigation application, to enable the relevant local weather conditions to be shown. The widget 714 may be selected by a user to launch a full screen version of the weather application.

In this case, the vehicle rental company is able to install and uninstall any of their own applications and those obtained from third parties, e.g. the weather application. However, the navigation application cannot be readily uninstalled by the company. The end user, i.e. driver, is limited to just being able to user the applications. Depending upon the context in which a PND is to be used, the end user may be provided with greater access rights, e.g. enabling them to install or uninstall applications from the vehicle hire service provider, or other parties, but will not be able to uninstall the navigation application.

The home screen also includes a navigation bar 716 to enable a driver to quickly launch certain applications.

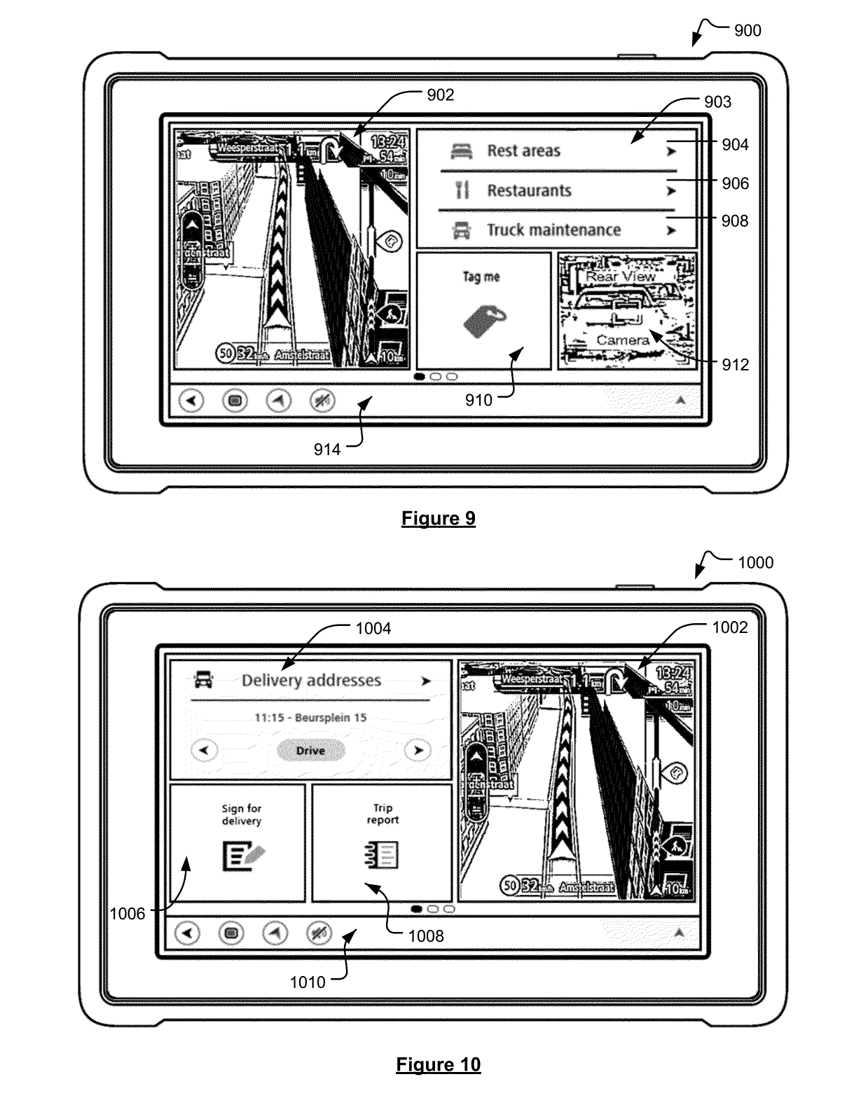

The exemplary arrangements regarding access rights of the device provider and end user described by reference to FIG. 7 may be used in any of the further examples of FIGS. 8 to 10.

FIG. 8 shows another example of a home screen 800, this time for a PND that has been configured by a taxi company for use by their drivers. The home screen includes a navigation widget 801 which is displaying progress along a route currently being travelled to a drop-off location for a passenger. The current position of the vehicle 802 with which the PND is associated is shown on a representation of a road being traversed, together with a portion of a remainder of the route 803, and an instruction regarding the next manoeuvre to be performed 804. A so-called route bar 805 is also shown, indicating an overview of progress along the route toward the destination. This navigation widget 801 is displaying information obtained from a navigation application installed on the device. In addition, a widget 806 associated with a payment meter application shows the current fare price, and the distance travelled since picking up the passenger. This widget has been installed by the taxi company, and is navigation enabled, being able to interact with the navigation application via an API of the PND. In this case, the widget has been able to obtain data relating to the origin of the route, and progress along the route, i.e. distance travelled, to enable the current fare price to be calculated. The home screen also includes a shortcut 807 to an application enabling the driver to see a representation of the current positions of all taxis in the fleet on a map. This may enable the driver to locate a region which is currently less well served by other taxis, and to travel to that region when they are free, to maximise likelihood of obtaining a fare. This application is also navigation enabled, being able to obtain data indicative of the current map matched positions of the taxis from the navigation application via the API. The application may use the navigation application to geocode, or reverse geocode the positions of the taxis. The PND may permit a driver to e-mail a receipt to a passenger upon arrival at a destination. The home screen also includes a navigation bar 808 to enable a driver to quickly launch certain applications.

FIG. 9 illustrates a home screen of a PND provided by an owner of a fleet of trucks to the individual truck drivers. The home screen 900 includes a navigation widget 902 associated with a navigation application, which, similar to the navigation widget 801 described by reference to FIG. 8, is displaying progress along a route being followed, together with an indication of the next manoeuvre and a route bar. On the right hand side there is a widget 903 comprising short cuts to three functions provided by an application of relevance to truck drivers, which has been installed by the owner. These are a rest areas function 904, a restaurant function 906 and a truck maintenance function 908. The application is navigation enabled, and thus able to interact with the navigation application via an API. For example, the rest area function may be arranged to obtain the current position of the truck from the navigation application, to enable nearby rest areas to be displayed. The rest area function may be arranged to provide a location of a given rest area to the navigation application to obtain a route thereto. The restaurant functionality may work similarly. The PND may include a navigation enabled application that will show the driver the location of service stations that offer truck parking. The home screen 900 also includes a tag me application 910 that allows the driver to ‘tag’ certain locations for future use, and a widget 912 to assist with parking. The widget 912 provides a rear view image using a rear view camera of the truck, and can also display a distance to the closest object behind the truck. The widget may be selected by a driver to provide a full screen view. In another example, the PND may include an application which utilises a camera of the PND to recognise the current driver, and to log the time driven. The home screen also includes a navigation bar 910 to enable a driver to quickly launch certain applications.

FIG. 10 illustrates a home screen 1000 for a device provided by a delivery service provider to their delivery drivers. The home screen includes a navigation widget 1002 associated with a navigation application installed on the PND, of a similar type to that used in the FIGS. 8 and 9 embodiments. On the left hand side is a delivery address widget 1004 associated with a delivery address application. This application is navigation enabled, and the widget is displaying the address of the next delivery. When the driver selects the button “drive”, the delivery address application will interact with the navigation application via the API to obtain a route to the address. This process may involve geocoding the street address illustrated, to enable the navigation application to determine coordinates of the address. The home screen additionally includes a short cut 1006 to a digital signature application enabling an addressee to sign for delivery of an item, and a short cut 1008 to a trip report application. Both of these applications may be navigation enabled via the API. For example, navigation enablement of the sign for delivery application may enable a current location of the PND at the time of signature to be obtained via the navigation application, to confirm delivery to the correct address. The trip report application may log details about routes driven, fuel consumption and/or driving style, based upon information obtained from the navigation application, to enable a driver to try to increase their driving efficiency, and/or for review by the delivery company. Other applications that might be installed on the device in this context would include a QR code scanner, a barcode scanner, or a flashlight. The home screen also includes a navigation bar 1010 to enable a driver to quickly launch certain applications.

In each of the above use cases described by reference to FIGS. 7 to 10, the PND offers a single solution, combining the providers own applications with a navigation application to enhance efficiency of service, and/or facilitate the role of the driver.

Any of the methods or devices in accordance with the present invention may be implemented at least partially using software, e.g. computer programs. The present invention thus also extends to a computer program comprising computer readable instructions executable to perform, or to cause a navigation device to perform, a method according to any of the aspects or embodiments of the invention, or to result in a navigation device in accordance with (i.e. configured to operate in accordance with) any of the aspects or embodiments of the invention. The invention correspondingly extends to a computer software carrier comprising such software which, when used to operate a navigation device comprising a set of one or more processors causes, in conjunction with said set of one or more processors, said device to operate or be configured in accordance with any of the embodiments of the present invention. Such a computer software carrier could be a non-transitory physical storage medium such as a ROM chip, CD ROM or disk, or could be a signal such as an electronic signal over wires, an optical signal or a radio signal such as to a satellite or the like. The present invention provides a machine readable medium containing instructions which when read by a set of one or more processors of a navigation device cause the navigation device to operate or be configured according to any of the aspects or embodiments of the invention.

Where not explicitly stated, it will be appreciated that the invention in any of its aspects may include any or all of the features described in respect of other aspects or embodiments of the invention to the extent they are not mutually exclusive.

1. A navigation device arranged to access digital map data indicative of a navigable network, and comprising: a display device; a user input device; a location determining device arranged to determine a current position of the device; and one or more processors arranged to:
execute a navigation application operable to determine a route from an origin to a destination through the navigable network using the digital map data, and to provide navigation instructions to guide a user along a determined route;
execute at least one further application, each said further application being an application which has been obtained, on request by a user, from a remote computer and installed on the navigation device, and each said further application being capable of being uninstalled, on request by the user, from the navigation device, wherein said at least one further application is capable of interacting with the navigation application using an application programming interface (API) to at least obtain information therefrom; and
execute application launcher software, for an operating system of the navigation device, to present a home screen on the display device, said home screen including at least one of: (i) one or more selectable graphical user interface (GUI) elements, each being associated with a said further application, and which, when selected by a user using the user input device, causes the execution of the associated further application; and (ii) one or more widgets, each being associated with a said further application, and displaying information associated with the respective further application, said displayed information being updated by the respective further application,
wherein said home screen is arranged to simultaneously display a navigation widget associated with the navigation application and at least one of: a said selectable GUI element; and a said widget, said navigation widget being arranged to display navigation instructions provided by the navigation application to guide the user along a determined route.

2. The navigation device of claim 1, wherein the home screen is arranged to simultaneously display the navigation widget associated with the navigation application and a widget associated with a further application, the navigation widget being arranged to display navigation instructions provided by the navigation application to guide the user along a determined route, and said displaying information based on information relating to the determined route obtained from the navigation application using the API.

3. The navigation device of claim 2, wherein the information relating to the determined route obtained from the navigation application includes one or more of: the origin and/or destination of the route; the progress along the route; the estimated time of arrival at the destination; and the current location of the device along the route.

4. The navigation device of claim 1, wherein the navigation widget is arranged to display a graphical representation of a current position of the navigation device in the navigable network and at least a portion of the remainder of the determined route, the graphical representation being updated as the user traverses the route toward the destination.

5. The navigation device of claim 2, wherein the navigation widget is arranged to display a graphical representation of a current position of the navigation device in the navigable network and at least a portion of the remainder of the determined route, the graphical representation being updated as the user traverses the route toward the destination.

6. The navigation device of claim 5, wherein the information relating to the determined route obtained from the navigation application includes one or more of: the origin and/or destination of the route; the progress along the route; the estimated time of arrival at the destination; and the current location of the device along the route.

7. The navigation device of claim 1, wherein interaction of at least one further application with the navigation application using the API enables the at least one further application to provide location data to the navigation application, and to receive at least one of geocoding location data and reverse geocoding location data from the navigation application.

8. The navigation device of claim 1, wherein interaction of at least one further application with the navigation application using the API enables the at least one further application to provide location data to the navigation application, and wherein the location represented by the location data is used by the navigation application as a destination when determining a route.

9. A non-transitory computer readable medium comprising computer readable instructions which, when executed by one or more processors of a navigation device arranged to access digital map data indicative of a navigable network, and comprising: a display device; a user input device; a location determining device arranged to determine a current position of the device, cause the one or more processors to:
execute a navigation application operable to determine a route from an origin to a destination through the navigable network using the digital map data, and to provide navigation instructions to guide a user along a determined route;
execute at least one further application, each said further application being an application which has been obtained, on request by a user, from a remote computer and installed on the navigation device, and each said further application being capable of being uninstalled, on request by the user, from the navigation device, wherein said at least one further application is capable of interacting with the navigation application using an application programming interface (API) to at least obtain information therefrom; and
execute application launcher software, for an operating system of the navigation device, to present a home screen on the display device, said home screen including at least one of: (i) one or more selectable graphical user interface (GUI) elements, each being associated with a said further application, and which, when selected by a user using the user input device, causes the execution of the associated further application; and (ii) one or more widgets, each being associated with a said further application, and displaying information associated with the respective further application, said displayed information being updated by the respective further application,
wherein said home screen is arranged to simultaneously display a navigation widget associated with the navigation application and at least one of: a said selectable GUI element; and a said widget, said navigation widget being arranged to display navigation instructions provided by the navigation application to guide the user along a determined route.

10. The computer readable medium of claim 9, wherein the home screen is arranged to simultaneously display the navigation widget associated with the navigation application and a widget associated with a further application, the navigation widget being arranged to display navigation instructions provided by the navigation application to guide the user along a determined route, and said displaying information based on information relating to the determined route obtained from the navigation application using the API.

11. The computer readable medium of claim 10, wherein the information relating to the determined route obtained from the navigation application includes one or more of: the origin and/or destination of the route; the progress along the route; the estimated time of arrival at the destination; and the current location of the device along the route.

12. The computer readable medium of claim 9, wherein the navigation widget is arranged to display a graphical representation of a current position of the navigation device in the navigable network and at least a portion of the remainder of the determined route, the graphical representation being updated as the user traverses the route toward the destination.

13. The computer readable medium of claim 10, wherein the navigation widget is arranged to display a graphical representation of a current position of the navigation device in the navigable network and at least a portion of the remainder of the determined route, the graphical representation being updated as the user traverses the route toward the destination.

14. The computer readable medium of claim 13, wherein the information relating to the determined route obtained from the navigation application includes one or more of: the origin and/or destination of the route; the progress along the route; the estimated time of arrival at the destination; and the current location of the device along the route.

15. The computer readable medium of claim 9, wherein interaction of at least one further application with the navigation application using the API enables the at least one further application to provide location data to the navigation application, and to receive at least one of geocoding location data and reverse geocoding location data from the navigation application.

16. The computer readable medium of claim 9, wherein interaction of at least one further application with the navigation application using the API enables the at least one further application to provide location data to the navigation application, and wherein the location represented by the location data is used by the navigation application as a destination when determining a route.

17. A navigation device arranged to access digital map data indicative of a navigable network, and comprising: a display device; a user input device; a location determining device arranged to determine a current position of the device; and one or more processors arranged to:
execute a navigation application operable to determine a route from an origin to a destination through the navigable network using the digital map data, and to provide navigation instructions to guide a user along a determined route;
execute at least one further application, each said further application being an application which has been obtained, on request by a user, from a remote computer and installed on the navigation device, and each said further application being capable of being uninstalled, on request by the user, from the navigation device; and
execute application launcher software, for an operating system of the navigation device, to present a home screen on the display device, said home screen including at least one of: (i) one or more selectable graphical user interface (GUI) elements, each being associated with a said further application, and which, when selected by a user using the user input device, causes the execution of the associated further application; and (ii) one or more widgets, each being associated with a said further application, and displaying information associated with the respective further application, said displayed information being updated by the respective further application,
wherein said home screen is arranged to simultaneously display a navigation widget associated with the navigation application and at least one of: a said selectable GUI element; and a said widget, said navigation widget being arranged to display navigation instructions provided by the navigation application to guide the user along a determined route, wherein said navigation instructions comprise a graphical representation of a current position of the navigation device in the navigable network and at least a portion of the remainder of the determined route, the graphical representation being updated as the user traverses the route toward the destination.

18. A non-transitory computer readable medium comprising computer readable instructions which, when executed by one or more processors of a navigation device arranged to access digital map data indicative of a navigable network, and comprising: a display device; a user input device; a location determining device arranged to determine a current position of the device, cause the one or more processors to:
execute a navigation application operable to determine a route from an origin to a destination through the navigable network using the digital map data, and to provide navigation instructions to guide a user along a determined route;
execute at least one further application, each said further application being an application which has been obtained, on request by a user, from a remote computer and installed on the navigation device, and each said further application being capable of being uninstalled, on request by the user, from the navigation device; and
execute application launcher software, for an operating system of the navigation device, to present a home screen on the display device, said home screen including at least one of: (i) one or more selectable graphical user interface (GUI) elements, each being associated with a said further application, and which, when selected by a user using the user input device, causes the execution of the associated further application; and (ii) one or more widgets, each being associated with a said further application, and displaying information associated with the respective further application, said displayed information being updated by the respective further application,
wherein said home screen is arranged to simultaneously display a navigation widget associated with the navigation application and at least one of: a said selectable GUI element; and a said widget, said navigation widget being arranged to display navigation instructions provided by the navigation application to guide the user along a determined route, wherein said navigation instructions comprise a graphical representation of a current position of the navigation device in the navigable network and at least a portion of the remainder of the determined route, the graphical representation being updated as the user traverses the route toward the destination.
